(19) United States
(12) Patent Application Publication
(10) Pub. No.: US 2026/0320228 A1
(43) Pub. Date: Oct. 15, 2026

(54) MODULAR SYNTHETIC DATA GENERATION

(71) Applicant: Rockfish Data, Inc., San Ramon, CA (US)

(72) Inventors: Deepti Mande, Foster City, CA (US); Nathan Haugo, Berkeley, CA (US); Muckai Girish, San Ramon, CA (US); Giulia Fanti, Pittsburgh, PA (US); Vyas Sekar, Pittsburgh, PA (US)

(21) Appl. No.: 19/642,245

(22) Filed: Apr. 8, 2026

Related U.S. Application Data
(60) Provisional application No. 63/786,121, filed on Apr. 9, 2025.

(51) Int. Cl. G06F 21/62; G06F 16/901; G06F 18/214

(52) U.S. Cl. CPC G06F 21/6245; G06F 16/9024; G06F 18/214

(57) ABSTRACT

A method for generating a transferable synthetic data generation workflow includes determining data properties of a locally-accessible seed dataset for inclusion in a candidate workflow, selecting preprocessing actions for inclusion in the candidate workflow based on the data properties and external requirements for the seed dataset, and storing the candidate workflow as a transferable synthetic data generation workflow in a remotely-accessible workflow storage. The selected preprocessing actions include one or more of data ingestion actions, data conditioning actions, data encoding actions, and data privacy actions. The method may be performed by an onboarding module, which may be included as part of a modular synthetic data generation system including other modules logically isolated from the onboarding module, such as a training module or a generation module.

### CROSS-REFERENCE TO RELATED APPLICATIONS

This application claims priority to Provisional Application No. 63/786,121 filed on April 9, 2025. The disclosure of the aforementioned application is hereby incorporated by reference in its entirety.

### TECHNICAL FIELD

The present invention relates generally to generative modeling, and, in particular embodiments, to systems and methods for generating transferable synthetic data generation workflows.

### BACKGROUND

Modern enterprises and service providers generate substantial volumes of operational data. Operational data encompasses various types of information produced during the normal operation of systems, applications, and services. Examples of operational data include system logs that record events and activities within computing systems, network telemetry that captures information about network traffic and performance, transaction traces that document the flow of transactions through distributed systems, sensor streams from Internet of Things (IoT) devices, and session-based data that tracks user interactions with applications and services. This operational data provides valuable insights into system behavior, performance characteristics, user patterns, and potential anomalies or issues that may require attention.

Conventional approaches to managing operational data typically involve transmitting the collected data from distributed sources to a central location for storage and processing. A central data storage and analytics platform may receive operational data from multiple sources and provide capabilities for querying, analyzing, and visualizing the data. Data scientists, analysts, and other stakeholders may access the centralized data repository to perform various analytical tasks and support decision-making processes. The centralized approach provides a unified view of operational data across the organization and enables analytics that require access to comprehensive datasets. However, the centralized approach to operational data management also presents several challenges, including substantial storage infrastructure requirements that incur significant costs as well as privacy and compliance considerations that complicate or limit operational data management. Data sparsity also presents additional challenges in operational data management.

Synthetic data generation may be able to address many of these challenges. Synthetic data is data that is generated algorithmically and is used as a replacement for real datasets in various settings, such as for replaying observed workloads, for demos, and for creating additional training data, among other things. Recent advances in the area of deep generative modeling have shown promise in using machine learning (ML) models to automatically create such synthetic datasets. These algorithms have the potential for learning high fidelity representations of multidimensional relationships in datasets thereby allowing users to flexibly tune synthetic data generation (e.g., augment events such as anomalous or sparse events), which would not otherwise be possible with raw/anonymized datasets.

Generative modeling techniques seek to learn underlying correlations in data that result in a particular distribution and then generate new data from that distribution. So-called “deep” generative modeling combines deep learning techniques with generative modeling to handle complex data distributions. Deep learning techniques, such as deep neural networks, use hidden layers (e.g., two or more) between input and output layers. While other (e.g., more niche) algorithms may exist, there are four general categories of deep generative algorithms: transformer techniques, generative adversarial network (GAN) techniques, variational autoencoder (VAE) techniques, and diffusion model techniques.

### SUMMARY

In accordance with an embodiment of the invention, a method for generating a transferable synthetic data generation workflow includes determining data properties of a locally-accessible seed dataset for inclusion in a candidate workflow, selecting preprocessing actions for inclusion in the candidate workflow based on the data properties and external requirements for the seed dataset, and storing the candidate workflow as a transferable synthetic data generation workflow in a remotely-accessible workflow storage. The selected preprocessing actions include one or more of data ingestion actions, data conditioning actions, data encoding actions, and data privacy actions.

In accordance with another embodiment of the invention, a non-transitory computer-readable medium stores a program that includes an onboarding module with instructions that, when executed by one or more processors, generate a transferable synthetic data generation workflow by determining data properties of a locally-accessible seed dataset for inclusion in a candidate workflow, selecting preprocessing actions for inclusion in the candidate workflow based on the data properties and external requirements for the seed dataset, and storing the candidate workflow as a transferable synthetic data generation workflow in a remotely-accessible workflow storage. The selected preprocessing actions include one or more of data ingestion actions, data conditioning actions, data encoding actions, and data privacy actions.

In accordance with still another embodiment of the invention, a modular synthetic data generation system includes an onboarding module configured to generate a transferable synthetic data generation workflow by determining data properties of a locally-accessible seed dataset for inclusion in a candidate workflow, selecting preprocessing actions and training actions for inclusion in the candidate workflow based on the data properties and external requirements for the seed dataset, and storing the candidate workflow as a transferable synthetic data generation workflow in a remotely-accessible workflow storage. The preprocessing actions include one or more of data ingestion actions, data conditioning actions, data encoding actions, and data privacy actions. The modular synthetic data generation system further includes a training module logically isolated from the onboarding module and configured to generate a trained generative model using the transferable synthetic data generation workflow by retrieving the transferable synthetic data generation workflow from the remotely-accessible workflow storage for an additional dataset having data properties similar to the data properties of the seed dataset, preprocessing the additional dataset using the selected preprocessing actions, training a model using the preprocessed additional dataset and the selected training actions to generate the trained generative model, and storing the trained generative model in a remotely-accessible model storage.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 illustrates a schematic block diagram of an example modular synthetic data generation system in accordance with embodiments of the disclosure;

FIG. 2 illustrates a flowchart of an end-to-end synthetic data generation process that uses an onboarding module, a training module, and a generation module to generate synthetic data based on seed data and external requirements in accordance with embodiments of the disclosure;

FIG. 3 illustrates an example onboarding module flowchart in accordance with embodiments of the disclosure;

FIG. 4 illustrates an example training module flowchart in accordance with embodiments of the disclosure;

FIG. 5 illustrates an example generation module flowchart in accordance with embodiments of the disclosure;

FIG. 6 illustrates several examples of time series data in accordance with embodiments of the disclosure;

FIG. 7 illustrates a visual representation of a conventional synthetic dataset generation process; and

FIG. 8 illustrates a visual representation of conventional longitudinal data storage pain points.

Corresponding numerals and symbols in the different figures generally refer to corresponding parts unless otherwise indicated. The figures are drawn to clearly illustrate the relevant aspects of the embodiments and are not necessarily drawn to scale. The edges of features drawn in the figures do not necessarily indicate the termination of the extent of the feature.

### DETAILED DESCRIPTION OF ILLUSTRATIVE EMBODIMENTS

The making and using of various embodiments are discussed in detail below. It should be appreciated, however, that the various embodiments described herein are applicable in a wide variety of specific contexts. The specific embodiments discussed are merely illustrative of specific ways to make and use various embodiments, and should not be construed in a limited scope.

Organizations collect operational data to support a wide range of data-driven workflows and business processes. Machine learning models may be trained on historical operational data to predict future trends, detect anomalies, or optimize system performance. Sales teams may use operational data to create demonstrations that showcase product capabilities to potential customers. Customer support teams may analyze operational data to diagnose and resolve incidents reported by customers. Quality assurance teams may use operational data to conduct testing and validation of new features or system configurations. Research and development teams may analyze operational data to identify opportunities for improvement or innovation.

The volume of operational data collected by organizations has grown substantially in recent years. Multiple data sources distributed across different geographic locations, data centers, edge computing environments, and cloud platforms continuously generate operational data. This data is typically collected at regular intervals, which may be referred to as epochs or time periods. For example, operational data may be collected hourly, daily, weekly, or at other intervals depending on the specific use case and requirements. The continuous nature of operational data collection results in longitudinal datasets that capture how systems, applications, and user behaviors evolve over time.

The centralized approach to operational data management presents several challenges. The storage of large volumes of continuously collected operational data requires substantial storage infrastructure and incurs significant costs. As operational data accumulates over time, the storage requirements grow correspondingly, potentially reaching petabyte or exabyte scales for large organizations. The transmission of operational data from distributed collection points to central storage locations consumes network bandwidth and incurs transmission costs. When data sources are geographically distributed across different regions or countries, the transmission costs and latency may be particularly significant.

Privacy and compliance considerations add additional complexity to operational data management. Operational data may contain sensitive information about customers, users, business operations, or proprietary systems. Various regulations and policies govern how such sensitive data may be collected, stored, transmitted, and shared. Requirements are imposed on organizations regarding the handling of personal data. Industry-specific regulations may impose additional requirements for certain sectors such as healthcare, finance, or telecommunications. Organizations may also have internal policies regarding data retention, access control, and data sharing that further constrain how operational data may be used.

Data access restrictions arising from privacy regulations, compliance requirements, and organizational policies can create bottlenecks that limit the ability of teams to access the operational data needed for their workflows. A data scientist seeking to train a machine learning model may be unable to access relevant operational data due to privacy restrictions. A sales engineer preparing a demonstration may lack access to realistic operational data that would make the demonstration more compelling. A customer support engineer troubleshooting an issue may be unable to access operational data from the customer's environment due to confidentiality concerns. These access restrictions can significantly impede productivity and limit the value that organizations can derive from their operational data.

Data sparsity presents another challenge in operational data management. While organizations may collect large volumes of operational data overall, specific types of events or conditions of interest may be relatively rare. Anomalous events, error conditions, security incidents, or edge cases may occur infrequently in production environments. The resulting datasets may have insufficient examples of these rare events to support effective analysis or machine learning model training. Imbalances across different data segments, such as different geographic regions, customer types, or usage patterns, can further complicate analytical tasks.

The application of synthetic data generation to operational data presents unique challenges compared to simpler data types. Operational data often exhibits complex temporal dependencies, sequential patterns, and relationships between different data elements. Time series data captures how variables evolve over time, with values at one time point potentially depending on values at previous time points. Session-based data tracks sequences of events or actions within a session, such as a user's interactions with a website or application. Event traces capture the flow of events through distributed systems, with causal relationships and timing constraints between events.

Domain-specific constraints and relationships in operational data add further complexity. Different fields or columns in operational datasets may have dependencies or relationships that should be preserved in synthetic data to maintain realism and utility. Multiple tables in a database may have relationships such as one-to-many, one-to-one, or parent-child relationships that should be maintained. Domain-specific business logic or physical constraints may impose requirements on valid combinations of values or sequences of events. Capturing and preserving these domain-specific characteristics in synthetic data generation requires sophisticated modeling approaches and domain expertise.

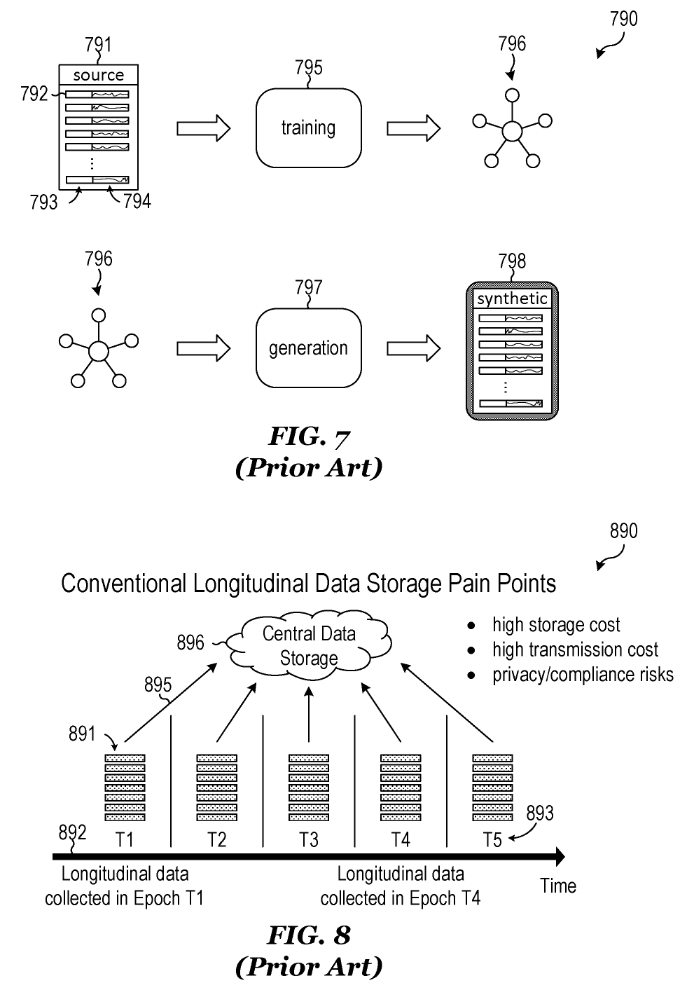

Synthetic data generation uses real data to train a generative model that can be used to generate synthetic data with similar properties as the real data. For example, a conventional synthetic data generation process that is used to manually generate a synthetic session dataset is illustrated in FIG. 7. Referring to FIG. 7, a conventional synthetic data generation process 790 trains a conventional generative model 796 using a source session dataset 791 and generates a conventional synthetic session data 798 using the conventional generative model 796.

The source session dataset 791 includes a set of source sessions 792 that each have a tuple of attributes 793 and time series data 794. The source session dataset 791 is input into a generative training model in a conventional training step 795 to generate a model of the source session dataset 791 that may be used to generate synthetic data that has similar properties as the source data. Specifically, the conventional generative model 796 is input into a generative generation model in a conventional generation step 797 to generate the conventional synthetic session data 798.

Any preprocessing of the source session dataset 791 is determined ab initio before being used as input during the conventional training step 795. As a result, any new generative models trained on new source datasets must also be similarly analyzed before a corresponding training step. The determination of appropriate preprocessing actions can have burdensome time, expertise, and access requirements. For example, a data scientist with appropriate clearance and expertise to view and use the source data may need to be onsite and devote valuable time to preprocessing source data before it is input into a generative training model. This may increase the resource cost (e.g., time, expertise) for creating generative models and may prevent some generative models from being created, such as when personnel having the requisite expertise are not able to access the data, whether because they are not in the appropriate location, do not have time to work on more projects, or do not have the necessary security clearance.

One way to provide access to new source data sets for training new generative models is to upload the source data to a central data storage, but this has several drawbacks. FIG. 8 illustrates conventional longitudinal data storage pain points 890, such as those associated with operational data processing workflows. FIG. 8 shows a conventional approach in which source datasets are transmitted to a centralized storage location over time. This conventional approach suffers from the constraints of high storage cost, high transmission cost, and privacy/compliance risks.

A source dataset 891 represents longitudinal data (e.g., operational data) collected and stored at a location, such as a data center, an edge computing environment, an on-premises server, or a cloud-hosted virtual machine. The source dataset 891 is representative of the type of data that enterprises and service providers continuously accumulate as part of normal operations. A time evolution 892 represents the passage of time along which the longitudinal data is continuously generated. The time evolution 892 indicates that data collection is not a one-time event, but rather an ongoing process in which new data accumulates at regular or irregular intervals. As time progresses along time evolution 892, multiple instances of source dataset 891 are collected at successive points in time.

Each instance of source dataset 891 collected along time evolution 892 is associated with a specific time period referred to in this example as an epoch 893. For instance, a first epoch may correspond to a first collection period during which a first instance of source dataset 891 is generated, and a second epoch may correspond to a subsequent collection period during which a second instance of source dataset 891 is generated. Multiple epochs 893 may span days, hours, weeks, or months, depending on the frequency at which the longitudinal data is collected. Each epoch 893 produces an instance of source dataset 891 that reflects the data patterns and statistical characteristics present during that collection period.

In the conventional approach depicted in FIG. 8, each instance of source dataset 891 collected at a respective epoch 893 is transmitted via a conventional data transmission step 895 to a conventional centralized data storage 896. The data transmission step 895 represents the transfer of the raw source dataset 891 over a network from the data-generating location to a central cloud environment or data warehouse. The centralized data storage 896 represents a central repository where the accumulated source datasets 891 are stored and made available for downstream data analytics, machine learning model training, incident response, and other data-driven workflows.

Because each epoch 893 produces an additional instance of source dataset 891 that is stored at centralized data storage 896, the total volume of stored data grows continuously over time. Longitudinal data, such as operational data, can be large in volume and the cumulative cost of retaining raw datasets across many epochs 893 can become substantial. Relatedly, each instance of source dataset 891 is transmitted in its entirety. Transmitting large volumes of raw data across network links, particularly across geographic regions or organizational boundaries, incurs bandwidth costs that scale proportionally with the size and frequency of the datasets being transferred, both of which are often high when dealing with longitudinal data.

Another pain point is privacy and compliance risk. The source dataset 891 may contain sensitive information such as personally identifiable information, customer records, proprietary business data, or other content subject to privacy regulations and data protection policies. Transmitting and storing the raw source dataset 891 at centralized data storage 896 can expose the data to privacy violations, regulatory non-compliance, and unauthorized access. Different jurisdictions and industries may impose different requirements on how such data may be collected, stored, transmitted, and shared, and ensuring compliance across all applicable requirements adds complexity to the conventional approach. Furthermore, certain data may not be broadly shareable within the organization itself, requiring access to centralized data storage 896 to be reduced thereby limiting the usefulness of the stored data.

Conventional approaches are further hindered by the coupling of the data collection, data transmission, and data utilization processes. Each instance of source dataset 891 can only be utilized for downstream workflows after it has been transmitted and stored at conventional centralized data storage 896. Personnel who require access to the data for analytics or model training can only access the data from the centralized location, and the data can only be shared with other teams or organizations by transferring the raw data itself. Conventional approaches do not provide a mechanism for decoupling the timescales at which data is collected, processed, and utilized. There are also no mechanisms for distributing data without exposing the underlying sensitive information.

In accordance with embodiments herein described, the disclosure proposes a modular synthetic data generation system and methods for generating a transferable synthetic data generation workflow for longitudinal data, such as operational data. The disclosed system addresses constraints that enterprises and service providers face when transmitting, storing, and sharing large volumes of longitudinal data (e.g., network telemetry, transaction traces, session-based event records, and sensor streams). Rather than transmitting and storing raw longitudinal data, aspects of the disclosure provide a synthetic data generation process with modular phases that produce compact, transferable workflows and model snapshots usable to generate synthetic data with similar statistical properties as the original data. From a workflow and new source data (e.g., streaming operational data), model snapshots can be generated without repeating lengthy onboarding processes or transmitting raw data from the original location. From a model snapshot, high-fidelity synthetic operational data can be regenerated on demand to support downstream workflows while preserving the statistical characteristics of the original data and eliding privacy-sensitive information.

Embodiments of the disclosure describe generating a transferable synthetic data generation workflow by determining data properties of a locally-accessible seed dataset for inclusion in a candidate workflow. Preprocessing actions may be selected for inclusion in the candidate workflow based on the data properties and external requirements for the seed dataset. The selected preprocessing actions may comprise one or more of data ingestion actions, data conditioning actions, data encoding actions, and data privacy actions. The candidate workflow may be stored as a transferable synthetic data generation workflow in a remotely-accessible workflow storage.

In one or more embodiments, the synthetic data generation workflow may be retrieved from the remotely-accessible workflow storage for additional datasets. For example, the workflow may be configured to be applied to data having properties that are similar to the properties of the seed dataset (e.g., automatically as part of the workflow for incoming operational data, such as streaming data). Specifically, an additional dataset may be preprocessed using the selected preprocessing actions in the workflow. A model may be trained using the preprocessed additional dataset to generate a trained generative model. In some embodiments, training actions are selected for inclusion in the candidate workflow based on the data properties, the selected preprocessing actions, and the external requirements, and the model may be trained using the selected training actions (e.g., automatically as part of the workflow).

The disclosed processes may be well-suited for streaming longitudinal data. In various embodiments, further additional datasets may be ingested using one or more data ingestion actions selected as part of the preprocessing actions. The further additional datasets may be preprocessed using the preprocessing actions, and models may be trained using the preprocessed further additional datasets to generate trained generative model snapshots. The trained generative model snapshots may be stored in a remotely-accessible model storage. The preprocessing actions may comprise data privacy actions usable to automatically enforce privacy requirements from the external requirements on new datasets to avoid compromising original data.

In one or more embodiments, the trained generative model may be stored in a remotely-accessible model storage, retrieved from the remotely-accessible model storage, and used to generate a synthetic dataset. Generation actions may be selected for inclusion in the candidate workflow based on the data properties, the selected preprocessing actions, and the external requirements, and the synthetic dataset may be generated using the selected generation actions (e.g., automatically as part of a workflow for generating on demand synthetic data for a particular use case). The transferable synthetic data generation workflow may define a complete end-to-end process beginning with preprocessing the additional dataset and ending with generating the synthetic dataset and satisfying the external requirements.

The candidate workflow may be evaluated and validated before storing as a transferable synthetic data generation workflow. In an embodiment, a model may be trained using the seed dataset according to the candidate workflow to generate a candidate generative model. A candidate synthetic dataset may be generated using the candidate generative model. The candidate synthetic dataset may be evaluated to determine whether the candidate workflow satisfies the external requirements. The candidate workflow may be stored as the transferable synthetic data generation workflow in response to determining that the candidate workflow satisfies the external requirements. If the candidate workflow does not satisfy the external requirements, the candidate workflow may be modified (or a new candidate workflow may be generated) for reevaluation.

Aspects of the disclosure describe a non-transitory computer-readable medium storing a program comprising an onboarding module including instructions that, when executed by one or more processors, generate a transferable synthetic data generation workflow. The onboarding module may comprise a configuration engine configured to traverse a directed graph by determining next nodes of the traversal at splitter nodes using the data properties of the seed dataset and the external requirements for the seed dataset, and ending the traversal at a leaf node of the directed graph. The leaf node may indicate the selected preprocessing actions. In various embodiments, the leaf node may indicate additional selected actions, such as training actions, generation actions, and others.

Embodiments of the disclosure describe a modular synthetic data generation system comprising an onboarding module and a training module logically isolated from the onboarding module. The onboarding module may be configured to generate the transferable synthetic data generation workflow by determining data properties of a locally-accessible seed dataset for inclusion in a candidate workflow, selecting preprocessing actions and training actions for inclusion in the candidate workflow based on the data properties and external requirements for the seed dataset, and storing the candidate workflow in a remotely-accessible workflow storage.

The training module may be configured to generate a trained generative model using the transferable synthetic data generation workflow by retrieving the transferable synthetic data generation workflow from the remotely-accessible workflow storage for an additional dataset having data properties similar to the data properties of the seed dataset, preprocessing the additional dataset using the selected preprocessing actions, training a model using the preprocessed additional dataset and the selected training actions to generate the trained generative model, and storing the trained generative model in a remotely-accessible model storage. In one or more embodiments, the onboarding module may be geographically isolated from the training module, and the modular synthetic data generation system may have an asymmetric decoupled architecture with distributed onboarding and training modules and the workflow storage as a shared database.

The modular synthetic data generation system may also include a generation module that is logically isolated from both the onboarding module and the training module. The generation module may be configured to generate a synthetic dataset using the trained generative model by retrieving the trained generative model from the remotely-accessible model storage and generating the synthetic dataset using the trained generative model. The onboarding module may further select generation actions for inclusion in the candidate workflow based on the data properties and the external requirements for the seed dataset, and the generation module may generate the synthetic dataset using the selected generation actions. In various embodiments, the onboarding module, the training module, and the generation module may be mutually geographically isolated, and the modular synthetic data generation system may have an asymmetric decoupled architecture with distributed onboarding, training, and generation modules and the workflow storage and the model storage as shared databases.

The disclosed modular architecture and the methods and processes described herein may have various advantages over conventional approaches as well as offer various improvements to the functioning of computers and to other technologies or technical fields. The decoupling of onboarding, training, and generation into logically isolable (e.g., fully self-contained geographically isolable modules) may advantageously enable different personnel (or personas) within an organization to handle different phases of the workflow without requiring universal data access or the presence of the seed dataset. Transferable synthetic data generation workflows and trained generative models (e.g., model snapshots) may be advantageously stored in remotely-accessible storage and retrieved by distributed modules from different network or geographic locations without exposing sensitive data. Continuous ingestion of datasets used to train generative model snapshots may beneficially enable current representations of evolving longitudinal data patterns (e.g., operational data patterns) to be maintained. The modules of the system may also have flexibility advantages, such as being deployable as software-as-a-service (SaaS) applications, fully on-premises (on-prem) installations, or in a hybrid mode, and may be integrable into existing machine learning operations pipelines. These and additional details are further discussed below.

Synthetic data that accurately captures large volumes of longitudinal source data (e.g., from one or more remote locations without continued input from data scientists) cannot be conventionally generated, whether by hand, in the human mind, or with basic tools, including general-purpose computing devices, or by using conventional computing systems configured to perform conventional synthetic data generation techniques, such as by transmitting entire datasets into a centralized data storage or from location to location. Specifically, conventional techniques have data limitations (including prohibitive transmission and storage requirements), resource limitations (such as time and expertise for onboarding new datasets and configuring end-to-end synthetic data generation workflows), and privacy/compliance limitations (including access restrictions, import/export restrictions, encryption requirements, authorization and consent requirements, data minimization restrictions, purpose restrictions, and others).

The proposed synthetic data generation methods described herein improve the field of synthetic data generation by decoupling the onboarding, training, and generation phases from a personnel perspective, data location perspective (whether logical, organizational, network, or physical location), and timescale perspective. The use of both workflows and generative models as transferable artifacts allows the proposed synthetic data generation methods to reduce data transmission and storage costs while increasing the volume and usefulness of the generated synthetic data. In many cases, synthetic data may be generated would not be possible at all with conventional techniques (e.g., due to transmission, storage, privacy, compliance, etc.). Additionally, various technological fields may be improved by the application of the proposed methods and processes to longitudinal data related to the field (e.g., operational data like system logs, network telemetry, transaction traces, and sensor streams), such as the fields of behavioral tracking, mobility research, data analysis, and others.

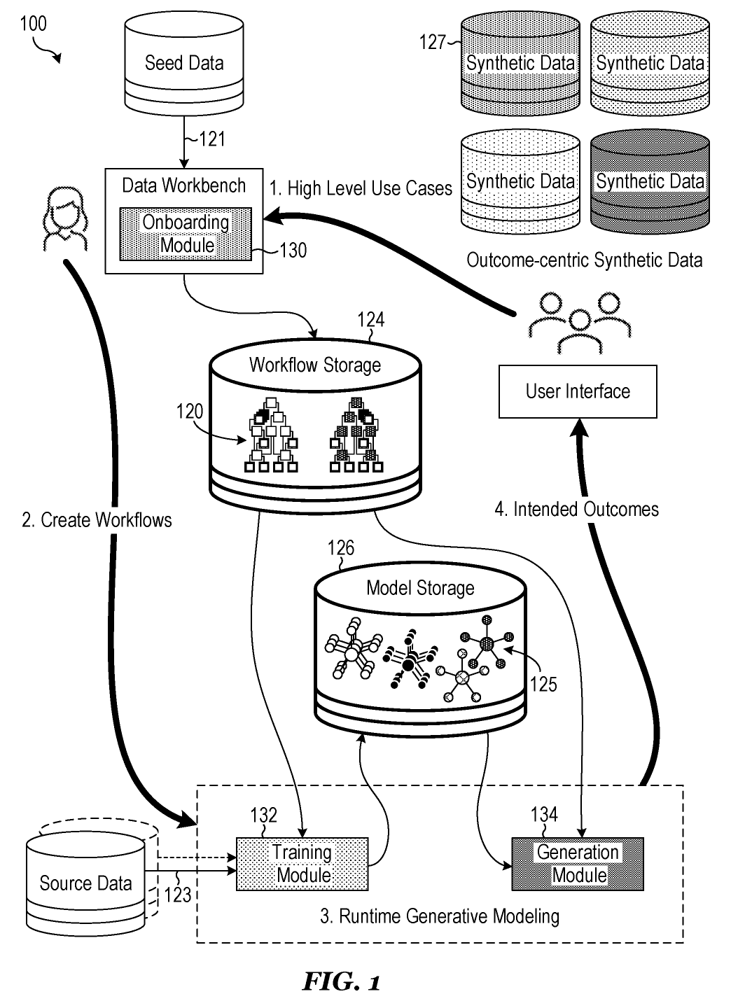

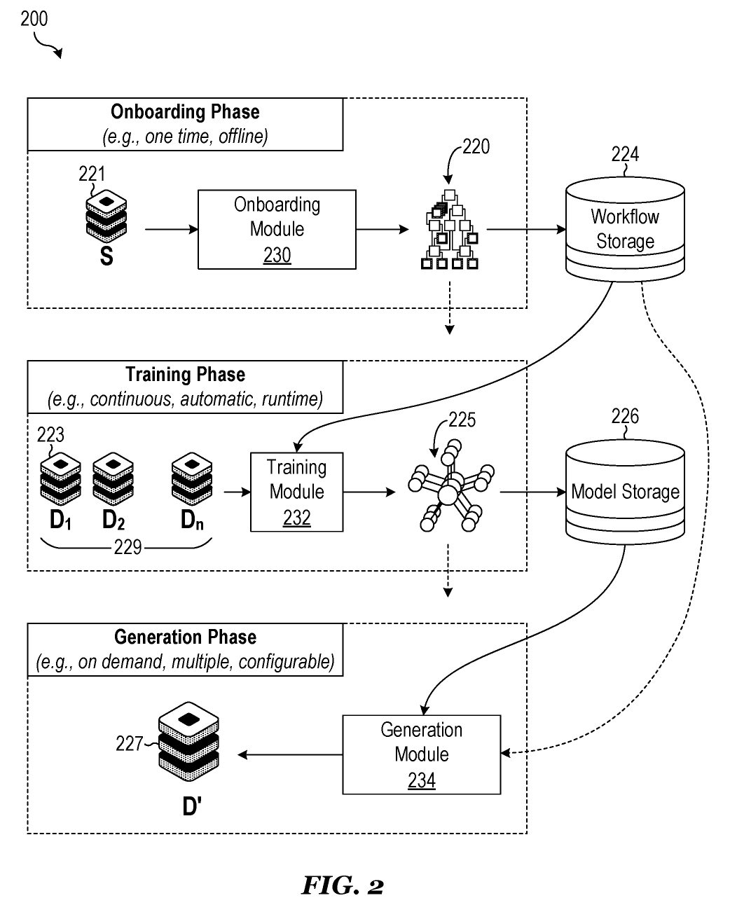

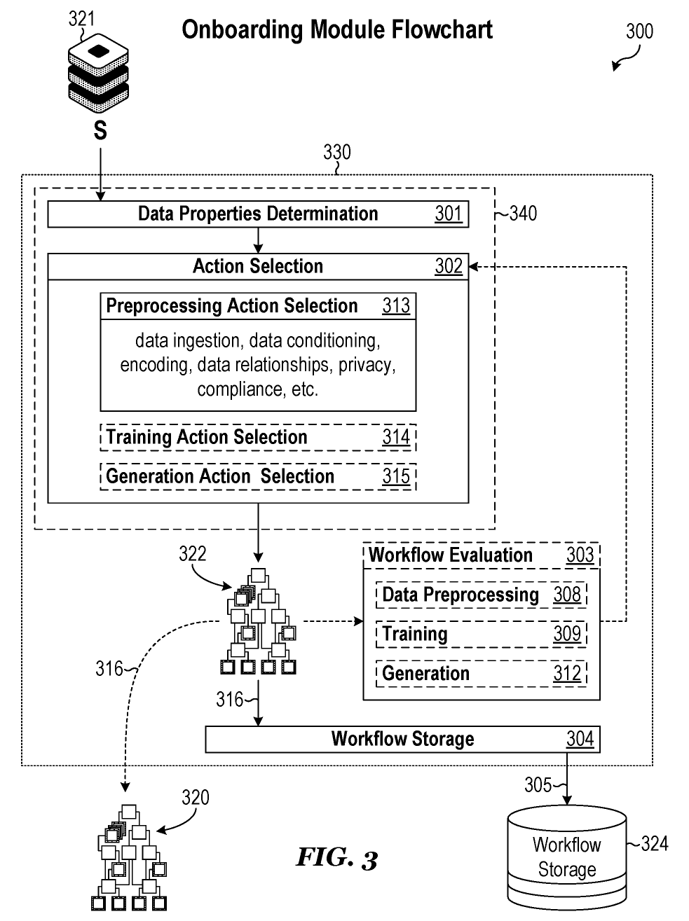

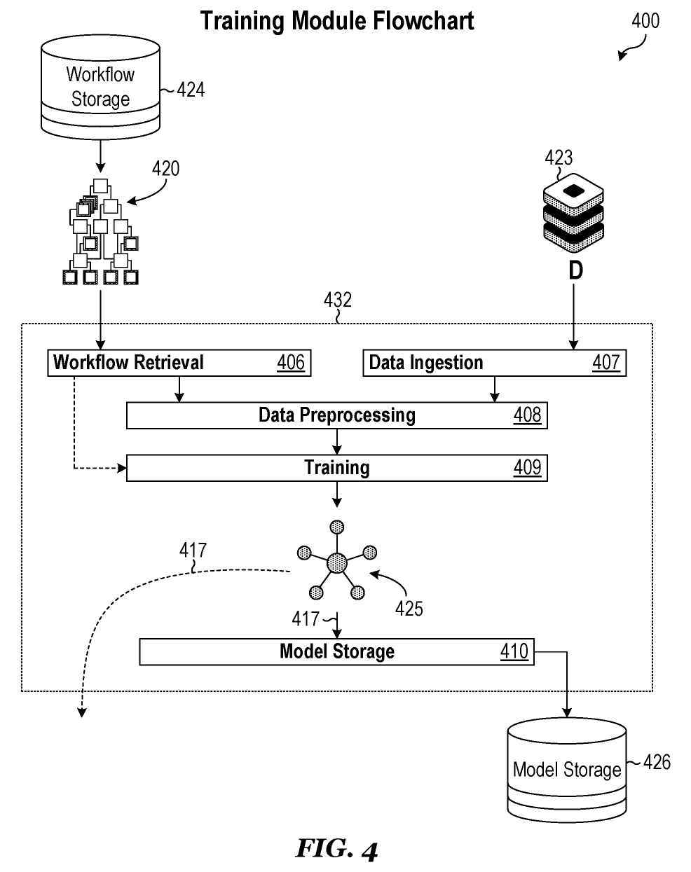

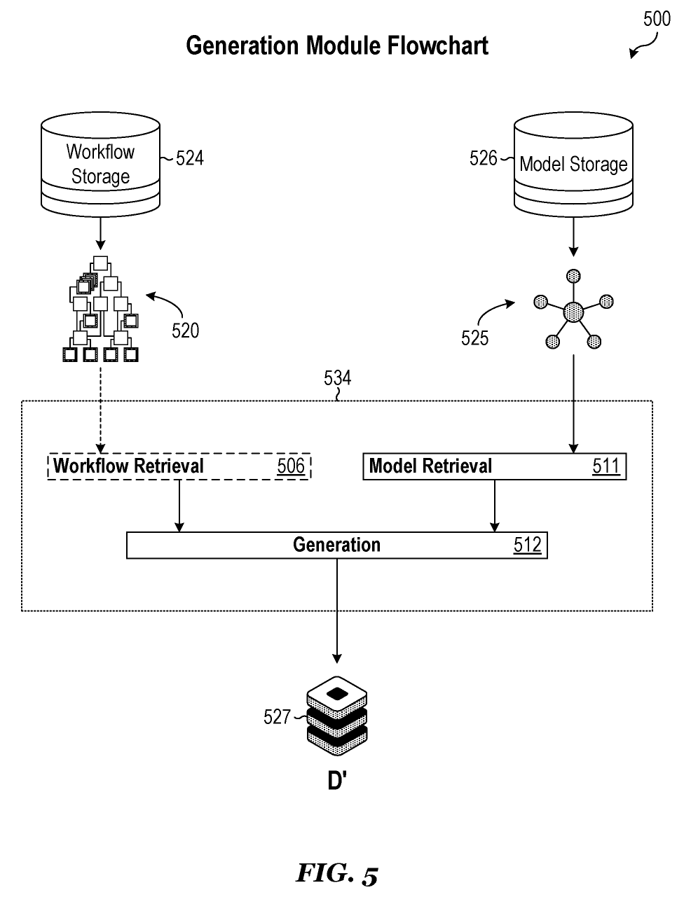

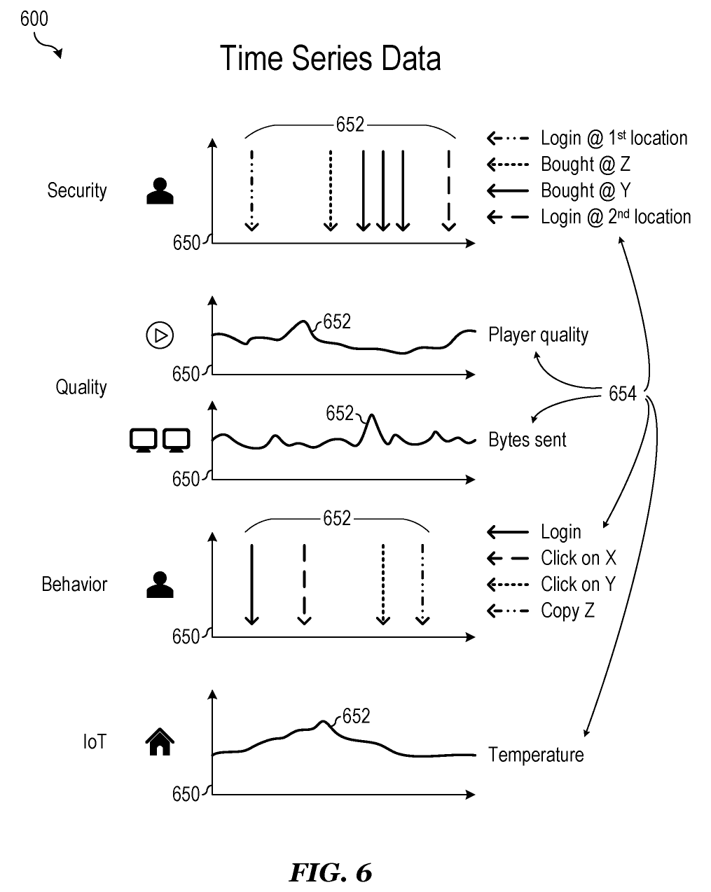

Embodiments provided below describe various methods for generating synthetic data, and in particular embodiments, to methods that use logically separate modules to transferable synthetic data generation workflows and trained generative models to generate synthetic data. The following description describes the embodiments. FIG. 1 is used to describe an example modular synthetic data generation system. FIG. 2 is used to describe an example end-to-end synthetic data generation process. An example onboarding module flowchart is described using FIG. 3. An example training module flowchart is described using FIG. 4. An example generation module flowchart is described using FIG. 5. FIG. 6 is used to describe several examples of time series data.

FIG. 1 illustrates a schematic block diagram of a modular synthetic data generation system 100 in accordance with implementations of the disclosure. The modular synthetic data generation system 100 is configured to generate synthetic data using logically separate phases for onboarding, training, and generation. Specifically, the modular synthetic data generation system 100 includes an onboarding module 130, a training module 132, and a generation module 134 that are configured to interface with one or more data storage systems that include a workflow storage 124, and a model storage 126. The modular synthetic data generation system 100 addresses constraints associated with conventional longitudinal data storage pain points by replacing the transmission and storage of raw datasets with transferable synthetic data generation workflows and trained generative models.

At a high level, synthetic data generation using the modular synthetic data generation system 100 has four basic steps. First, high level use cases for data are determined. For example, stakeholders may express use cases that define the intended downstream tasks for synthetic data, such as incident response, stress testing, or sales demonstrations. Next, one or more workflows are created using onboarding module 130, which is configured to process a seed dataset 121 and generate a synthetic data generation workflow 120 based on external requirements informed by the use cases. The synthetic data generation workflow 120 is stored in workflow storage 124 (although it could also be used directly by a training module in some embodiments. The synthetic data generation workflow 120 is retrieved from workflow storage 124 by training module 132 during runtime generative modeling. Specifically, training module 132 is configured to use the synthetic data generation workflow 120 to train generative models 125 on one or more source datasets 123. Generation module 134 can retrieve generative model 125 from the model storage 126 and generate synthetic dataset 127. Downstream users can then access synthetic dataset 127 (e.g., through a user interface to obtain outcome-centric synthetic data for the originally-specified high level use cases.

In various embodiments, onboarding module 130 comprises a recommendation engine configured to generate some or all of synthetic data generation workflow 120 based on seed dataset 121 and external requirements. The recommendation engine may comprise a dataset property extraction component configured to determine dataset-level and field-level properties of seed dataset 121, a train recommendation component configured to recommend training actions for generating a generative model, and a generation recommendation component configured to recommend generation actions for generating synthetic data from a stored generative model. By way of example, the dataset property extraction component may determine whether seed dataset 121 adheres to a tabular data model or a session-timeseries data model, identify session keys, timestamps, metadata fields, measurement fields, data types, missing-value properties, value ranges, category counts, privacy-related properties, and associations or dependency rules among fields. The recommended actions may then be selected using the determined properties and the external requirements, and may be presented for review, modification, or approval by a user before storage as synthetic data generation workflow 120.

Onboarding module 130 determines data properties of seed dataset 121 for inclusion in a candidate workflow. In various embodiments, the data properties comprise one or more of data classification, data structure, data type, and data relationships. For example, onboarding module 130 may categorize the seed dataset 121 based on its structure (e.g., tabular, time series, session-based, etc.). Onboarding module 130 may also validate seed dataset 121 by checking for inconsistencies such as missing values, duplicates, or data type mismatches.

Onboarding module 130 is configured to select preprocessing actions for inclusion in the candidate workflow based on the data properties and external requirements for seed dataset 121. In some embodiments, a user (such as a data scientist) may provide input that onboarding module 130 uses to select some or all of the preprocessing actions. In other embodiments, onboarding module 130 is configured to automatically select the preprocessing actions based on the external requirements (e.g., using a configuration engine). For example, a data scientist may review and override automatic selections.

The external requirements may include one or more of domain-specific constraints, privacy requirements, compliance requirements, and fidelity requirements. These external requirements (along with the extracted data properties) inform the selection of the preprocessing actions. A wide variety of preprocessing actions may be selected from in order to handle different data types and use cases. For example, the preprocessing actions may include one or more of data ingestion actions, data conditioning actions, data encoding actions, and data privacy actions. Onboarding module 130 may also select training actions and generation actions for inclusion in the candidate workflow based on the data properties, the selected preprocessing actions, and the external requirements.

Onboarding module 130 may evaluate the candidate workflow before storing it as the synthetic data generation workflow 120. A model may be trained using seed dataset 121 according to the candidate workflow to generate a candidate generative model. A candidate synthetic dataset may be generated using the candidate generative model. The candidate synthetic dataset may be evaluated to determine whether the candidate workflow satisfies the external requirements. The candidate workflow may be stored as the synthetic data generation workflow 120 in response to determining that the candidate workflow satisfies the external requirements. If the candidate workflow does not satisfy the external requirements, the candidate workflow may be modified or a new candidate workflow may be generated for reevaluation.

The synthetic data generation workflow 120 is transferable. That is, the synthetic data generation workflow 120 may be transmitted to and stored in other locations, whether logical or geographical, and is configured to be usable by other modules, including other workflow modules, training modules, and (optionally) generation modules. The synthetic data generation workflow 120 defines at least the preprocessing steps for preparing a dataset with similar data properties as seed dataset 121 for training. In embodiments, the synthetic data generation workflow 120 defines a complete workflow for training generative models and generating synthetic data from datasets with similar data properties as seed dataset 121. As used herein, a “workflow” may comprise a sequence, a directed graph, or another executable arrangement of actions and associated parameters for processing one or more datasets or models.

In embodiments, the synthetic data generation workflow 120 may be a collection of actions arranged as a directed graph. The synthetic data generation workflow 120 includes preprocessing actions, and may also include training actions and/or generation actions. In one embodiment, the synthetic data generation workflow 120 defines a complete end-to-end process beginning with preprocessing a source dataset (e.g., an additional dataset that is not the seed dataset) and ending with generating a synthetic dataset that satisfies the external requirements.

Workflow storage 124 is configured as a remotely-accessible storage from which the synthetic data generation workflow 120 can be retrieved by distributed modules (e.g., at different logical or geographical locations). Workflow storage 124 may serve as a shared database in an asymmetric decoupled architecture. Workflow storage 124 enables the synthetic data generation workflow 120 to be accessed by training module 132 and generation module 134 without requiring access to seed dataset 121 or to onboarding module 130.

Training module 132 is logically isolated from onboarding module 130. Training module 132 is configured to retrieve the synthetic data generation workflow 120 from workflow storage 124 for a source dataset 123. The source dataset 123 is an additional dataset having data properties similar to the data properties of seed dataset 121. In various embodiments, the source dataset 123 includes operational data that is collected at a location different from the location at which seed dataset 121 was collected. The source dataset 123 may be entered manually, streamed from local databases, or streamed from cloud databases.

Training module 132 is configured to preprocess the source dataset 123 using the selected preprocessing actions from the synthetic data generation workflow 120 and to train a model using the preprocessed source dataset to generate a generative model 125. In embodiments, the synthetic data generation workflow 120 includes selected training actions that training module 132 is configured to perform to generate the generative model 125. In some embodiments, the preprocessing actions from the synthetic data generation workflow 120 include data privacy actions usable to automatically enforce privacy requirements from the external requirements on the source dataset 123 to avoid compromising original data.

Training module 132 may ingest further additional datasets. In embodiments, training module 132 is configured to ingest source data on a continuous or periodic basis using one or more data ingestion actions selected as part of the preprocessing actions in the synthetic data generation workflow 120. For example, training module 132 may be configured to preprocess the further additional datasets using the preprocessing actions and train models using the preprocessed further additional datasets to generate trained generative model snapshots. The trained generative model snapshots may correspond to different epochs or time periods of the ingested data. Training module 132 is configured to store trained generative models in model storage 126.

In some embodiments, each repetition of data ingestion step 407, data preprocessing step 408, and model training step 409 produces a model snapshot associated with a corresponding batch, epoch, time period, location, or dataset version. Model storage 426 may store the model snapshots together with associated metadata, such as labels, timestamps, version identifiers, workflow identifiers, encoding metadata identifiers, geographic identifiers, or use-case identifiers. The stored model snapshots may thereby provide a compact and queryable historical representation of evolving source data without requiring retention or transmission of the underlying raw datasets.

In some embodiments, one or more actions of training module 432 are executed as jobs scheduled by a control plane onto one or more worker nodes in a data plane. Different actions within a training workflow may be scheduled to different worker nodes based on compute requirements, locality constraints, privacy constraints, or model type. For example, one or more privacy-sensitive preprocessing actions may be executed in an on-premises or otherwise isolated environment while one or more training actions may be executed in a hosted compute environment.

Model storage 126 is also configured as a remotely-accessible storage from which the generative model 125 can be retrieved by generation module 134. Similar to workflow storage 124, model storage 126 may serve as a shared database in an asymmetric decoupled architecture. In various embodiments, model storage 126 is configured to store multiple generative models or generative model snapshots corresponding to different time periods, datasets, or configurations. Model storage 126 enables access to and query of stored generative models for on-demand synthetic data generation.

Generation module 134 is logically isolated from both onboarding module 130 and training module 132. Generation module 134 is configured to retrieve the generative model 125 from model storage 126 and generate the synthetic dataset 127 using the generative model 125. In various embodiments, generation module 134 is configured to generate synthetic dataset 127 using generation actions selected as part of the synthetic data generation workflow 120, which may also be retrieved from workflow storage 124 by generation module 134. In embodiments, generation module 134 may be configured to allow users to specify generation parameters, such as the volume of synthetic data, target features, or conditional generation constraints, to produce outcome-centric synthetic data tailored to specific use cases. In various embodiments, the synthetic data generation workflow 120 may provide baseline generation actions and parameters that may be used to generate the synthetic dataset 127 or may be modified by a user before generating the synthetic dataset 127.

The synthetic dataset 127 is an output of generation module 134. The synthetic dataset 127 may include synthetic data generated for one or more use cases, such as privacy-preserving data export, stress testing datasets, scenario simulation, machine learning training data augmentation, or conditional generation targeting specific data subsets. Multiple instances of synthetic dataset 127 may be generated from a single generative model 125 or from different generative model snapshots stored in model storage 126.

The modular synthetic data generation system 100 may have an asymmetric decoupled architecture with distributed onboarding, training, and generation modules and workflow storage 124 and model storage 126 as shared databases. Specifically, the modular synthetic data generation system 100 may have one or more onboarding modules feeding workflow storage accessible by multiple training modules. The training modules may feed model storage that is accessible by and multiple (e.g., even more) generation modules (which may also have access to the workflow storage.

The modular synthetic data generation system 100 may also be geographically distributed. For example, onboarding module 130 may be geographically isolated from training module 132. Further, onboarding module 130, training module 132, and generation module 134 may be mutually geographically isolated. Each of onboarding module 130, training module 132, and generation module 134 may be deployed as a software-as-a-service application, an on-premises installation, or in a hybrid mode.

In some embodiments, modular synthetic data generation system 100 further comprises a control plane and a data plane. User interfaces, software development kits, notebooks, command-line interfaces, or natural-language interfaces may generate or modify synthetic data generation workflow 120, and the control plane may translate actions in the synthetic data generation workflow 120 into executable jobs. The jobs may be scheduled onto worker nodes in the data plane having heterogeneous compute capabilities, such as different central processing unit, graphics processing unit, memory, or locality characteristics. Intermediate data products and model artifacts produced by the worker nodes may be stored in temporary or persistent stores and referenced by later actions in the workflow.

FIG. 2 illustrates a flowchart of an end-to-end synthetic data generation process 200 in accordance with implementations of the disclosure. The end-to-end synthetic data generation process 200 may be performed by a modular synthetic data generation system, such as described above with respect to FIG. 1. Referring to FIG. 2, the end-to-end synthetic data generation process 200 includes an onboarding phase, a training phase, and a generation phase that operate on different timescales and are decoupled from one another through the use of workflow storage 224 and model storage 226.

The onboarding phase may be performed one time and may be performed offline. During the onboarding phase, onboarding module 230 receives seed dataset 221 (labeled S) and generates a synthetic data generation workflow 220. It should be noted that here and in the following a convention has been adopted for brevity and clarity wherein elements adhering to the pattern [x30] where ‘x’ is the figure number may be related implementations of an onboarding module in various embodiments. For example, onboarding module 230 may be similar to onboarding module 130 except as otherwise stated. An analogous convention has also been adopted for other elements as made clear by the use of similar terms in conjunction with the aforementioned numbering system.

Onboarding module 230 is configured to determine data properties of seed dataset 221 and select preprocessing actions (and optionally other actions such as training actions and generation actions) based on the data properties and external requirements. In embodiments, onboarding module 230 is further configured to evaluate the resulting candidate workflow. Once the candidate workflow satisfies the external requirements, onboarding module 230 is configured to store the synthetic data generation workflow 220 in workflow storage 224.

The onboarding phase may account for a substantial portion of the total effort involved in establishing a synthetic data generation pipeline. During the onboarding phase, personnel with appropriate domain expertise and data access, such as data scientists or data engineers, may evaluate the seed dataset 221 (in conjunction with a configuration engine in some embodiments) and specify the external requirements, including domain-specific constraints, privacy requirements, compliance requirements, and fidelity requirements. Because onboarding module 230 is configured to produce the synthetic data generation workflow 220 as a transferable artifact that can be stored in workflow storage 224, the onboarding phase does not have to be repeated for subsequent datasets that have data properties similar to the data properties of the seed dataset 221. The storage of synthetic data generation workflow 220 in workflow storage 224 decouples the onboarding phase from the training phase.

Training module 232 is configured to receive source dataset 223. In various embodiments, the training phase may be configured to continuously or periodically ingest incoming source datasets (e.g., as streaming datasets 229 (labeled D₁, D2, through Dₙ). For example, the synthetic data generation workflow 220 may include data ingestion actions as part of the preprocessing actions and training module 232 may be configured to use the data ingestion actions to continuously ingest provided datasets. Streaming datasets 229 may arrive at intervals of hours, days, weeks, or months, depending on the frequency at which the operational data is collected. The training process may be fully automatic and may be performed at runtime.

During the training phase, training module 232 retrieves the synthetic data generation workflow 220 from workflow storage 224 and uses the synthetic data generation workflow 220 to process incoming data and generate trained generative models (e.g., trained generative model snapshots). For example, each trained generative model snapshot may be a generative model 225 that captures the statistical properties of the data collected during a corresponding time period.

Training module 232 may advantageously not require the personnel who performed the onboarding phase, require no access to the seed dataset 221, and not require the onboarding phase to be repeated. Training module 232 is configured to operate using the synthetic data generation workflow 220 retrieved from workflow storage 224, which contains the workflow actions (the preprocessing actions and optionally other actions, such as training actions and/or generation actions) and other configuration information established during the onboarding phase. Training module 232 may be coupled to data sources such as local databases, cloud databases, or operational pipelines from which the streaming datasets 229 are ingested.

The storage of the generative model 225 in model storage 226 decouples the training phase from the generation phase. As training module 232 ingests streaming datasets 229 over time and produces new trained generative model snapshots, model storage 226 accumulates a collection of generative models that each correspond to a respective time period of the ingested data. These generative models may be used on demand to generate synthetic data without being influenced by the rate at while real data is obtained and ingested by training module 232.

During the generation phase, generation module 234 is configured to retrieve the generative model 225 from model storage 226 and to generate a synthetic dataset 227 (labeled D'). The generation phase may be a configurable process that is performed on demand, may be performed multiple times, at multiple locations, and may be performed in parallel.

Some or all of the generation phase may by automated (e.g., using the synthetic data generation workflow 220). For example, generation module 234 may also be configured to retrieve the synthetic data generation workflow 220 from workflow storage 224 to use generation actions specified in synthetic data generation workflow 220. Generation actions that are included in the synthetic data generation workflow 220 may also serve as a default or baseline state that can be modified (e.g., by a user) to further tailor the synthetic dataset 227 to the intended use case. That is, generation module 234 may allow users to specify generation parameters, such as conditional generation constraints targeting specific data subsets, to produce outcome-centric synthetic data. For example, a user may specify criteria to select a subset of the statistical representation captured by a generative model and generation module 234 may generate synthetic dataset that reflects only the specified subset.

In some embodiments, generation module 534 determines one or more post-processing actions based on preprocessing actions previously applied during training. For example, generation module 534 may retrieve synthetic data generation workflow 520, determine one or more corresponding reverse transforms, filtering actions, formatting actions, or export actions, and apply the determined actions to generated output prior to storing or exporting synthetic dataset 527. A user may provide generation requirements including a requested number of samples, one or more target populations, one or more filtering conditions, one or more output destinations, or one or more scenario parameters, and generation module 534 may use the provided generation requirements to modify default generation actions specified in synthetic data generation workflow 520.

Generation module 234 does not require access to the streaming datasets 229. Generation module 234 also does not require storage capacity to maintain the raw datasets from which the generative models were trained. Instead, generation module 234 is configured to generate a synthetic dataset 227 from any generative model stored in model storage 226.

FIG. 3 illustrates an onboarding module flowchart 300 in accordance with implementations of the disclosure. The onboarding module flowchart 300 depicts operations performed by an onboarding module 330 during the onboarding phase of an end-to-end synthetic data generation process, such as described above with respect to FIG. 2. One or more onboarding modules may be included in a modular synthetic data generation system, such as described above with respect to FIG. 1. Although shown in a logical order, the arrangement and numbering of the steps of FIG. 3 are not intended to be limited. The method steps of FIG. 3 may be performed in any suitable order or concurrently with one another as may be apparent to a person of skill in the art.

Onboarding module 330 is configured to receive a seed dataset 321 and to generate a synthetic data generation workflow 320 that is stored in workflow storage 324. The onboarding module flowchart 300 includes a data properties determination step 301, an action selection step 302, (optionally) a workflow evaluation step 303, and a workflow storage step 304. At data properties determination step 301, onboarding module 330 determines data properties of seed dataset 321 for inclusion in a candidate workflow 322. The data properties may comprise one or more of data classification, data structure, data type, and data relationships. Data classification may include categorizing the seed dataset 321 based on its structure, such as tabular, time series, or session-based.

Onboarding module 330 may be configured to automatically determine the data properties using a dataset property extraction component. Onboarding module 330 may also validate the seed dataset 321 at data properties determination step 301 by checking for inconsistencies such as missing values, duplicates, or data type mismatches. The data properties included in the candidate workflow may used to determine appropriate actions for inclusion in the workflow.

In various embodiments, the dataset property extraction component is configured to determine both dataset-level properties and field-level properties. The dataset-level properties may include a data model classification, one or more data model-specific properties, and one or more fidelity or privacy properties. For example, when seed dataset 321 is classified as session-timeseries data, the dataset-level properties may include a session key, a timestamp, one or more metadata fields, and one or more measurement fields. The field-level properties may include an arrow type or other data type, an encoder type, a missing-value indicator, a default fill value, a category count for categorical fields, a value range for continuous fields, and an identified privacy type for sensitive fields. The dataset property extraction component may also determine field-to-field association rules or dependency constraints to be preserved during synthetic data generation.

At action selection step 302, onboarding module 330 selects actions as part of the candidate workflow 322 based on the data properties determined at data properties determination step 301 and external requirements for the seed dataset 321. During action selection step 302, onboarding module 330 selects preprocessing actions (step 313) as part of candidate workflow 322. The selected preprocessing actions may include various actions (e.g., depending on the specific data properties and external requirements of a given use case). For example, the selected preprocessing actions may include one or more of data ingestion actions, data conditioning actions, data encoding actions, data relationship actions, and data privacy actions.

In some embodiments, action selection step 302 comprises invoking one or more recommendation components that recommend actions and corresponding action parameters for inclusion in candidate workflow 322. For example, a train recommendation component may recommend a workflow that includes dataset loading, one or more preprocessing actions, and one or more model training actions. A generation recommendation component may recommend a workflow that includes one or more model generation actions, one or more optional post-processing or filtering actions, and one or more export or sink actions. The recommendation components may use the determined data properties, external requirements, and optionally available runtime resource constraints to recommend actions and configurations that satisfy fidelity, privacy, compliance, cost, or performance goals.

Some example tasks that may be performed as various workflow actions are provided in the following (although many more may be possible). Data ingestion actions may define how or when data is uploaded or streamed into the system, such as through file uploads, application programming interface integrations, or database connections. Data conditioning actions may include filling in missing values, combining datasets, downsampling, reducing dimensionality, or resampling. Data encoding actions may include normalization, scaling, or encoding transformations to prepare data for model training. Data relationship actions may include actions to handle fields that are dependent on one another, associated with one another, or to handle related timestamps in the dataset. Data privacy actions may include remapping actions, masking actions, generalization actions, or replacement actions to remove or alter sensitive data and meet compliance or privacy requirements for the data.

Additional actions may also be selected during action selection step 302, such as training actions (step 314) and/or generation actions (step 315). For example, selecting training actions may allow the workflow to be used by a training module to automate not just preprocessing but also some or all of the training of new data. When not used for full or partial automation, training actions included in a workflow may be at least used as baseline or default actions that can be verified or modified by a user interfacing with a training module. Similarly, selecting generation actions to be included in the workflow may enable automation and/or baseline actions for a generation module.

When training actions are selected, onboarding module 330 is configured to select the training actions based on the data properties and the external requirements. In many cases, the selection of training actions also depends on which preprocessing actions are selected. This may also be true when generation actions are selected. Further, training action selections may also inform generation action selection. The training actions may include model selection actions and hyperparameter selection actions that determine which generative model architecture and training parameters are used during model training.

Trained generative models may be able to generate synthetic data without additional input (or with little additional input). In various embodiments, trained generative models are configurable, allowing various parameters to be defined so that the generated synthetic data meets specific use case requirements. The generation actions may selected so that the workflow defines how synthetic data is produced from a trained generative model. For example, generation actions may include generation parameters and conditional generation constraints that may fully or partially automate the generation process or serve as baseline generation parameters.

Some or all of the data properties determination step 301 and the action selection step 302 may be performed by onboarding module 330 using a configuration engine 340. Configuration engine 340 may be configured to traverse a directed graph by determining next nodes of the traversal at splitter nodes using the data properties of the seed dataset 321 and the external requirements for the seed dataset 321. As a directed graph, later decisions also depend on previous decisions made in the tree. The traversal may end at a leaf node of the directed graph.

Leaf nodes may indicate the selected actions (i.e., at least preprocessing actions, including determinations not use certain preprocessing actions, and optionally including training actions and generation actions). Configuration engine 340 may further be configured to return a list of recommended actions, which may allow a user (e.g., a data scientist qualified to onboard the seed dataset) to review and modify (e.g., override) selected actions for inclusion in the candidate workflow according to domain knowledge.

After performing action selection step 302, onboarding module 330 has generated a candidate workflow that may be finalized as synthetic data generation workflow 320 provided as a workflow output 316. In some embodiments, the synthetic data generation workflow 320 may be output directly (dashed arrow), such as when the synthetic data generation workflow 320 is used immediately, such as for additional datasets onsite. During workflow storage step 304, onboarding module 330 is configured to store the candidate workflow 322 as the synthetic data generation workflow 320 in workflow storage 324, which is configured to be remotely-accessible. In various embodiments, onboarding module 330 is included as part of a modular synthetic data generation system and is not directly accessible by other modules.

The synthetic data generation workflow 320 is transferable and includes the selected workflow actions (preprocessing actions and, optionally, training actions, and generation actions). The synthetic data generation workflow 320 also includes the data properties (e.g., as a dataset report). For example, the data properties may be used by a training module to compare with a new dataset to determine whether the workflow is appropriate for the new dataset.

Workflow storage 324 may provide a centralized storage location for synthetic data generation workflows. Workflow storage step 304 may include transmission (step 305) of the synthetic data generation to workflow storage 324. Once the synthetic data generation workflow 320 is stored in workflow storage 324, it can be retrieved by other modules (e.g., a training module) and applied to additional datasets having data properties similar to the data properties of the seed dataset 321 without repeating the onboarding phase shown in the onboarding module flowchart 300.

Once the candidate workflow 322 is generated, onboarding module 330 may be configured to evaluate the candidate workflow 322 at workflow evaluation step 303 to determine whether it satisfies the external requirements. Workflow evaluation step 303 may include actual generation of synthetic data. For example, during workflow evaluation step 303, onboarding module 330 may be configured to apply the candidate workflow 322 to the seed dataset 321 by performing data preprocessing step 308 using the selected preprocessing actions, performing model training step 309 to train a model using the preprocessed seed dataset (optionally using selected training actions) to generate a candidate generative model, and performing synthetic data generation step 312 to generate a candidate synthetic dataset using the candidate generative model (optionally using selected generation actions).

During workflow evaluation step 303, onboarding module 330 may be configured to assess fidelity, accuracy, and potential discrepancies between the candidate synthetic dataset and the seed dataset 321. The evaluation may also assess whether the candidate synthetic dataset complies with the privacy requirements specified in the external requirements. Onboarding module 330 may use a synthetic data assessment component to perform the evaluation of workflow evaluation step 303.

During workflow evaluation step 303, onboarding module 330 may evaluate candidate workflow 322 using one or more statistical, structural, privacy, or utility assessments. The evaluation may include, for example, one or more univariate distribution comparisons, association or correlation assessments, session-length comparisons, interarrival-time comparisons, state-transition comparisons, privacy assessments, or downstream utility assessments. In response to determining that one or more evaluation criteria are not satisfied, onboarding module 330 may modify candidate workflow 322 by changing one or more preprocessing actions, encoders, privacy actions, model selections, hyperparameters, generation actions, or evaluation thresholds and may repeat workflow evaluation step 303.

If the candidate workflow 322 does not satisfy the external requirements, onboarding module 330 may modify the candidate workflow 322 or generate a new candidate workflow 322 and repeat action selection step 302 and workflow evaluation step 303 (dashed arrow). That is, the evaluation process may be iterative, with onboarding module 330 configured to cycle through action selection step 302 and workflow evaluation step 303 until the candidate workflow satisfies the external requirements. While there is no requirement that data properties determination step 301 be performed only once, in various embodiments, evaluation iterations may skip data properties determination step 301 (as shown) since the same seed dataset is being used and presumably still has the same properties regardless of whether the candidate workflow 322 met the external requirements.

Onboarding module 330 may be implemented as a non-transitory computer-readable medium storing a program comprising instructions that, when executed by one or more processors, perform data properties determination step 301, action selection step 302, workflow evaluation step 303 (when included), and workflow storage step 304 to generate synthetic data generation workflow 320. Optionally, a training module and a generation module may be used to perform the training (data preprocessing step 308 and model training step 309) and generation (synthetic data generation step 312) steps of the workflow evaluation step 303.

FIG. 4 illustrates a training module flowchart 400 in accordance with implementations of the disclosure. The training module flowchart 400 depicts the operations performed by a training module 432 during the training phase of an end-to-end synthetic data generation process, such as described above with respect to FIG. 2. One or more training modules (e.g., corresponding to or related to the number of sites or sources of generated data, such as operational data, for example) may be included in a modular synthetic data generation system, such as described above with respect to FIG. 1. Although shown in a logical order, the arrangement and numbering of the steps of FIG. 4 are not intended to be limited. The method steps of FIG. 4 may be performed in any suitable order or concurrently with one another as may be apparent to a person of skill in the art.

Training module 432 is configured to receive a source dataset 423 (e.g., retrieving a synthetic data generation workflow 420 from workflow storage 424) and generate a generative model 425 that may be stored in model storage 426. The training module flowchart 400 shows a workflow retrieval step 406, a data ingestion step 407, a data preprocessing step 408, a model training step 409, and a model storage step 410. The synthetic data generation workflow 420 is used by the training module 432 to generate the generative model 425 from the source dataset 423 using the synthetic data generation workflow 420.

At workflow retrieval step 406, training module 432 retrieves the synthetic data generation workflow 420 from workflow storage 424. The synthetic data generation workflow 420 is a transferable artifact that was generated and stored (e.g., by an onboarding module) during a prior onboarding phase. Training module 432 is not configured to (and does not need to) determine preprocessing actions (and optionally training actions), but instead uses the actions already defined in the synthetic data generation workflow 420. Additionally, in some embodiments, training module 432 is also not configured to determine data properties of the source dataset 423 or performs a simplified determination for comparison purposes.

In various embodiments, data preprocessing step 408 includes one or more encoding operations that transform source dataset 423 into a representation suitable for model training. The encoding operations may include, for example, one-hot encoding, label encoding, state-based encodings, numerical transforms, dimensionality-reduction transforms, sampling transforms, or combinations thereof. In some embodiments, training module 432 maintains or accesses an encoding metadata store that stores dictionaries, mappings, or other encoding metadata associated with one or more dataset types, fields, or time periods. The encoding metadata store may be updated over time as newly ingested datasets introduce new values or categories. Accordingly, training module 432 may use per-epoch encoding metadata, incrementally updated encoding metadata, or another tracked encoding state to preserve correctness as the domain of field values evolves over time.

At data ingestion step 407, training module 432 ingests the source dataset 423. The source dataset 423 is an additional dataset having data properties similar to the data properties of the seed dataset used during an onboarding phase. The source dataset 423 may be streamed from a local database or a cloud database. The source dataset 423 may alternatively be entered manually, such as through a file upload. Training module 432 may ingest source dataset 423 as a single dataset or may ingest multiple datasets over time as part of a continuous or periodic ingestion pipeline. When ingesting datasets, training module 432 may be configured to use one or more data ingestion actions defined in the synthetic data generation workflow 420 to receive each incoming dataset.

At data preprocessing step 408, training module 432 preprocesses the source dataset 423 using the preprocessing actions from the synthetic data generation workflow 420. For example, data preprocessing step 408 may apply the similar transformations to the source dataset 423 that were used (e.g., and validated) for a seed dataset during an onboarding phase. The preprocessing actions may also include data privacy actions that automatically enforce privacy requirements from the external requirements on the source dataset 423 to avoid compromising original data.

At model training step 409, training module 432 trains a model using the preprocessed source dataset to generate the generative model 425. Training module 432 may be configured to use training actions from the synthetic data generation workflow 420. The training actions may determine the generative model architecture and training parameters used during model training step 409. The generative model 425 captures the properties (e.g., statistical properties, schema, feature mappings, encoding and decoding parameters, and metadata) of the source dataset 423 but does not include the actual data.

At model storage step 410, training module 432 stores generative model 425 in model storage 426. Model storage 426 is a remotely-accessible centralized repository where trained generative models are stored. Model storage 426 may be physically or logically separate from workflow storage. Alternatively model storage 426 may be combined with workflow storage. Model storage 426 may be configured as a database that supports management, versioning, and deployment of stored generative models. Model output 417 represents the output of training module 432 at model training step 409 (i.e., direct output shown as a dashed arrow) and model storage step 410.

For streamed data, data ingestion step 407, data preprocessing step 408, model training step 409, and model storage step 410 may be repeated for each additional dataset. In various embodiments, workflow retrieval step 406 need not be repeated since the synthetic data generation workflow 420 is used for each dataset (which may have the advantage of further reducing transmission costs). Each repetition of training module flowchart 400 produces a trained generative model (e.g., a model snapshot that corresponds to a respective epoch or time period of the ingested data). Training module 432 is configured to each trained generative model snapshot in model storage 426 via model storage step 410. Over time, model storage 426 accumulates a collection of generative models that each capture the data patterns present during a corresponding collection period. Other training modules may also contribute to the model collection, creating a library of models (that are not the actual data), but can be used to generate synthetic data on demand for intended use cases.

Training module 432 may be implemented as a non-transitory computer-readable medium storing a program comprising instructions that, when executed by one or more processors, perform workflow retrieval step 406, data ingestion step 407, data preprocessing step 408, model training step 409, and model storage step 410 to generate and store the generative model 425.

FIG. 5 illustrates a generation module flowchart 500 in accordance with implementations of the disclosure. The generation module flowchart 500 depicts operations performed by a generation module 534 during the generation phase of an end-to-end synthetic data generation process, such as described above with respect to FIG. 2. One or more generation modules (e.g., many generation modules relative to other modules, such as onboarding modules, for example) may be included in a modular synthetic data generation system, such as described above with respect to FIG. 1. Although shown in a logical order, the arrangement and numbering of the steps of FIG. 5 are not intended to be limited. The method steps of FIG. 5 may be performed in any suitable order or concurrently with one another as may be apparent to a person of skill in the art.

Generation module 534 is configured to retrieve a generative model 525 from model storage 526 and a generate synthetic dataset 527. The generation module flowchart 500 shows a model retrieval step 511 and a synthetic data generation step 512. Optionally, the generation module flowchart 500 may also include a workflow retrieval step 506 during which generation module 534 is configured to retrieve a synthetic data generation workflow 520 from workflow storage 524.

At model retrieval step 511, generation module 534 retrieves the generative model 525 from model storage 526. The generative model 525 is transferable artifact that was trained (i.e., generated) and stored, such as using a training module, during a prior training phase. Generation module 534 may be configured to automatically select the generative model 525 from model storage 526 using criteria, such as desired dataset properties, a time period of the data, or a geographic region of the data. This criteria may be included in the synthetic data generation workflow 520 or specified by a user interfacing with generation module 534. Generation module 534 may also receive a manual selection of generative model 525 from a user.

At workflow retrieval step 506, generation module 534 may optionally retrieve the synthetic data generation workflow 520 from workflow storage 524. For example, the synthetic data generation workflow 520 may include generation actions that were selected during an onboarding phase. The generation actions may define default generation parameters, conditional generation constraints, or other configuration information for synthetic data generation step 512.

At synthetic data generation step 512, generation module 534 generates the synthetic dataset 527 using the generative model 525. Generation module 534 may be configured to allow users to specify generation parameters that configure synthetic data generation step 512. Such configuration parameters may also be included in the synthetic data generation workflow 520, when used.

In various embodiments, synthetic data generation step 512 comprises one or more generation operations selected from unconditional generation, conditional generation, amplification generation, filtered generation, blended generation, or combinations thereof. For example, generation module 534 may generate synthetic data that amplifies a selected cohort, incident type, or statistical pattern represented in generative model 525. In another example, generation module 534 may generate synthetic data subject to one or more filtering expressions, label conditions, structured constraints, or query expressions. In yet another example, generation module 534 may retrieve multiple generative models from model storage 526 and perform blended generation or multi-model generation to produce a synthetic dataset that combines characteristics from multiple model snapshots, time periods, or source domains.

Generation module 534 may be configured to perform conditional generation at synthetic data generation step 512. For conditional generation, generation module 534 may generate the synthetic dataset 527 based on specified conditions or constraints that target a subset of the statistical representation captured by the generative model 525. For example, a user may specify criteria that constrain the generated data to a particular geographic region, a particular time period, a particular demographic segment, or a particular combination of feature values. A user may also specify parameters for extrapolating data outside of the parameters of the original source data. Generation module 534 may be configured to generate the synthetic dataset 527 so that it follows particular patterns, distributions, or dependencies defined by the specified conditions.

Generation module 534 may be implemented as a non-transitory computer-readable medium storing a program comprising instructions that, when executed by one or more processors, perform model retrieval step 511, workflow retrieval step 506, and synthetic data generation step 512 to generate the synthetic dataset 527.

FIG. 6 illustrates several examples of time series data in accordance with embodiments of the disclosure. Referring to FIG. 6, time series data examples 600 are shown graphically as discrete or continuous data with time as the x-axis. Each set of time series data 650 includes one or more records 652 (which may be events that occur at certain moments in time or may be continuously measured values of interest). The records 652 have features 654, which are the values of the records that are tracked during the time interval of the time series data 650.

The time series data 650 may be included as part of sessions in a session dataset. For example, each of the sessions may include attributes (i.e., metadata) that is associated with different instances of the time series data. In the specific example of electronics communications, the metadata may be packet information, such as packet source, destination, and ports while time series data (i.e., measurements) may be a sequence of packet sizes recorded at each instance in time. Another specific example is finance where metadata may be demographic and geographic data of a bank customer and the time series data may include a sequence of actions such as deposits, withdrawals, etc.

As shown in FIG. 6, examples of time series data include security data where user interactions with an electronic system (e.g., logins, buying activity), such as an online marketplace is tracked and each user may be a session. Other types of time series data that may have sessions corresponding to users include connection quality data and user behavior (e.g., within a computer system). However, sessions do not have to be users, and may be objects such as computer hardware or measurement devices (such as IoT devices). For example, an IoT thermostat may be a session and temperature may be tracked as time series data. Of course, there is no requirement that the measurement device by internet-enabled.

While the inventive aspects are described primarily in the context of longitudinal operational data such as system logs, network telemetry, transaction traces, and sensor streams collected by enterprises and service providers, it should also be appreciated that these inventive aspects may also apply to other types of time-dependent data collected across various domains. In particular, aspects of this disclosure may similarly apply to healthcare data collected over time from patients, financial transaction data tracking market activities or customer behaviors, manufacturing data from production lines and quality control systems, retail data capturing customer purchasing patterns and inventory movements, transportation and logistics data tracking vehicle movements and delivery operations, and scientific research data from experiments and observations conducted over extended periods. The modular architecture for decoupling onboarding, training, and generation phases, along with the use of transferable workflows and generative models to represent data collected at different time periods, can provide similar benefits of reduced storage costs, lower transmission costs, and enhanced privacy protection across these diverse application domains.

Example embodiments of the disclosure are summarized here. Other embodiments can also be understood from the entirety of the specification as well as the claims filed herein.

Example 1. A method for generating a transferable synthetic data generation workflow, the method including: determining data properties of a locally-accessible seed dataset for inclusion in a candidate workflow; selecting preprocessing actions for inclusion in the candidate workflow based on the data properties and external requirements for the seed dataset, the selected preprocessing actions including one or more of data ingestion actions, data conditioning actions, data encoding actions, and data privacy actions; and storing the candidate workflow as a transferable synthetic data generation workflow in a remotely-accessible workflow storage.

Example 2. The method of example 1, further including: retrieving the transferable synthetic data generation workflow from the remotely-accessible workflow storage for an additional dataset having data properties similar to the data properties of the seed dataset; preprocessing the additional dataset using the selected preprocessing actions; and training a model using the preprocessed additional dataset to generate a trained generative model.

Example 3. The method of example 2, further including: selecting training actions for inclusion in the candidate workflow based on the data properties, the selected preprocessing actions, and the external requirements, where the generative model is trained using the selected training actions.

Example 4. The method of example 3, further including: ingesting further additional datasets using one or more data ingestion actions selected as part of the preprocessing actions; preprocessing the further additional datasets using the preprocessing actions; training models using the preprocessed further additional datasets to generate trained generative model snapshots; and storing the trained generative model snapshots in a remotely-accessible model storage.

Example 5. The method of one of examples 2 and 3, where the preprocessing actions include data privacy actions usable to automatically enforce privacy requirements from the external requirements on new datasets to avoid compromising original data.

Example 6. The method of one of examples 2 to 4, further including: storing the trained generative model in a remotely-accessible model storage; retrieving the trained generative model from the remotely-accessible model storage; and generating a synthetic dataset using the trained generative model.

Example 7. The method of example 6, further including: selecting generation actions for inclusion in the candidate workflow based on the data properties, the selected preprocessing actions, and the external requirements, where the synthetic dataset is generated using the selected generation actions.

Example 8. The method of example 7, where the transferable synthetic data generation workflow defines a complete end-to-end process beginning with preprocessing the additional dataset and ending with generating the synthetic dataset and satisfying the external requirements.

Example 9. The method of one of examples 1 to 8, further including: training a model using the seed dataset according to the candidate workflow to generate a candidate generative model; generating a candidate synthetic dataset using the candidate generative model; evaluating the candidate synthetic dataset to determine whether the candidate workflow satisfies the external requirements; and storing the candidate workflow as the transferable synthetic data generation workflow in response to determining that the candidate workflow satisfies the external requirements.

Example 10. The method of one of examples 1 to 9, where the locally-accessible seed dataset includes operational data.

Example 11. A non-transitory computer-readable medium storing a program including an onboarding module including instructions that, when executed by one or more processors, generate a transferable synthetic data generation workflow by: determining data properties of a locally-accessible seed dataset for inclusion in a candidate workflow; selecting preprocessing actions for inclusion in the candidate workflow based on the data properties and external requirements for the seed dataset, the preprocessing actions including one or more of data ingestion actions, data conditioning actions, data encoding actions, and data privacy actions; and storing the candidate workflow as a transferable synthetic data generation workflow in a remotely-accessible workflow storage.

Example 12. The non-transitory computer-readable medium of example 11, where the onboarding module includes a configuration engine configured to: traverse a directed graph of the configuration engine by determining next nodes of the traversal at splitter nodes using the data properties of the seed dataset and the external requirements for seed dataset, and ending the traversal at a leaf node of the directed graph, the leaf node indicating the selected preprocessing actions.

Example 13. The non-transitory computer-readable medium of example 12, where the leaf node indicates both the selected preprocessing actions and training actions selected for inclusion in the candidate workflow.

Example 14. The non-transitory computer-readable medium of one of examples 12 and 13, where the leaf node indicates both the selected preprocessing actions and generation actions selected for inclusion in the candidate workflow.

Example 15. The non-transitory computer-readable medium of one of examples 11 to 14, where the program includes further instructions that, when executed by the one or more processors, generate the transferable synthetic data generation workflow by: training a model using the seed dataset according to the candidate workflow to generate a candidate generative model; generating candidate synthetic data using the candidate generative model; evaluating the candidate synthetic data to determine whether the candidate workflow satisfies the external requirements; and storing the candidate workflow as the transferable synthetic data generation workflow in response to determining that the candidate workflow satisfies the external requirements.

Example 16. A modular synthetic data generation system including: an onboarding module configured to generate a transferable synthetic data generation workflow by determining data properties of a locally-accessible seed dataset for inclusion in a candidate workflow, selecting preprocessing actions and training actions for inclusion in the candidate workflow based on the data properties and external requirements for the seed dataset, the preprocessing actions including one or more of data ingestion actions, data conditioning actions, data encoding actions, and data privacy actions, and storing the candidate workflow as a transferable synthetic data generation workflow in a remotely-accessible workflow storage; and a training module logically isolated from the onboarding module and configured to generate a trained generative model using the transferable synthetic data generation workflow by retrieving the transferable synthetic data generation workflow from the remotely-accessible workflow storage for an additional dataset having data properties similar to the data properties of the seed dataset, preprocessing the additional dataset using the selected preprocessing actions; and training a model using the preprocessed additional dataset and the selected training actions to generate the trained generative model, and storing the trained generative model in a remotely-accessible model storage.

Example 17. The modular synthetic data generation system of example 16, where the onboarding module is geographically isolated from the training module, the modular synthetic data generation system having an asymmetric decoupled architecture with distributed onboarding and training modules and the workflow storage as a shared database.

Example 18. The modular synthetic data generation system of one of examples 16 and 17, further including: a generation module logically isolated from both the onboarding module and the training module, the generation module being configured to generate a synthetic dataset using the trained generative model by retrieving the trained generative model from the remotely-accessible model storage, and generating the synthetic dataset using the trained generative model.

Example 19. The modular synthetic data generation system of example 18, where the onboarding module is further configured to generate the transferable synthetic data generation workflow by selecting generation actions for inclusion in the candidate workflow based on the data properties and the external requirements for the seed dataset, and where the generation module is configured to generate the synthetic dataset using the selected generation actions.

Example 20. The modular synthetic data generation system of example 19, where the onboarding module, the training module, and the generation module are mutually geographically isolated, the modular synthetic data generation system having an asymmetric decoupled architecture with distributed onboarding, training, and generation modules and the workflow storage and the model storage as shared databases.

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

What is claimed is:

1. A method for generating a transferable synthetic data generation workflow, the method comprising:
determining data properties of a locally-accessible seed dataset for inclusion in a candidate workflow;
selecting preprocessing actions for inclusion in the candidate workflow based on the data properties and external requirements for the seed dataset, the selected preprocessing actions comprising one or more of data ingestion actions, data conditioning actions, data encoding actions, and data privacy actions; and
storing the candidate workflow as a transferable synthetic data generation workflow in a remotely-accessible workflow storage.

2. The method of claim 1, further comprising:
retrieving the transferable synthetic data generation workflow from the remotely-accessible workflow storage for an additional dataset having data properties similar to the data properties of the seed dataset;
preprocessing the additional dataset using the selected preprocessing actions; and
training a model using the preprocessed additional dataset to generate a trained generative model.

3. The method of claim 2, further comprising:
selecting training actions for inclusion in the candidate workflow based on the data properties, the selected preprocessing actions, and the external requirements,
wherein the generative model is trained using the selected training actions.

4. The method of claim 3, further comprising:
ingesting further additional datasets using one or more data ingestion actions selected as part of the preprocessing actions;
preprocessing the further additional datasets using the preprocessing actions;
training models using the preprocessed further additional datasets to generate trained generative model snapshots; and
storing the trained generative model snapshots in a remotely-accessible model storage.

5. The method of claim 2, wherein the preprocessing actions comprise data privacy actions usable to automatically enforce privacy requirements from the external requirements on new datasets to avoid compromising original data.

6. The method of claim 2, further comprising:
storing the trained generative model in a remotely-accessible model storage;
retrieving the trained generative model from the remotely-accessible model storage; and
generating a synthetic dataset using the trained generative model.

7. The method of claim 6, further comprising:
selecting generation actions for inclusion in the candidate workflow based on the data properties, the selected preprocessing actions, and the external requirements,
wherein the synthetic dataset is generated using the selected generation actions.

8. The method of claim 7, wherein the transferable synthetic data generation workflow defines a complete end-to-end process beginning with preprocessing the additional dataset and ending with generating the synthetic dataset and satisfying the external requirements.

9. The method of claim 1, further comprising:
training a model using the seed dataset according to the candidate workflow to generate a candidate generative model;
generating a candidate synthetic dataset using the candidate generative model;
evaluating the candidate synthetic dataset to determine whether the candidate workflow satisfies the external requirements; and
storing the candidate workflow as the transferable synthetic data generation workflow in response to determining that the candidate workflow satisfies the external requirements.

10. The method of claim 1, wherein the locally-accessible seed dataset comprises operational data.

11. A non-transitory computer-readable medium storing a program comprising an onboarding module including instructions that, when executed by one or more processors, generate a transferable synthetic data generation workflow by:
determining data properties of a locally-accessible seed dataset for inclusion in a candidate workflow;
selecting preprocessing actions for inclusion in the candidate workflow based on the data properties and external requirements for the seed dataset, the preprocessing actions comprising one or more of data ingestion actions, data conditioning actions, data encoding actions, and data privacy actions; and
storing the candidate workflow as a transferable synthetic data generation workflow in a remotely-accessible workflow storage.

12. The non-transitory computer-readable medium of claim 11, wherein the onboarding module comprises a configuration engine configured to:
traverse a directed graph of the configuration engine by
determining next nodes of the traversal at splitter nodes using the data properties of the seed dataset and the external requirements for seed dataset, and
ending the traversal at a leaf node of the directed graph, the leaf node indicating the selected preprocessing actions.

13. The non-transitory computer-readable medium of claim 12, wherein the leaf node indicates both the selected preprocessing actions and training actions selected for inclusion in the candidate workflow.

14. The non-transitory computer-readable medium of claim 12, wherein the leaf node indicates both the selected preprocessing actions and generation actions selected for inclusion in the candidate workflow.

15. The non-transitory computer-readable medium of claim 11, wherein the program includes further instructions that, when executed by the one or more processors, generate the transferable synthetic data generation workflow by:
training a model using the seed dataset according to the candidate workflow to generate a candidate generative model;
generating candidate synthetic data using the candidate generative model;
evaluating the candidate synthetic data to determine whether the candidate workflow satisfies the external requirements; and
storing the candidate workflow as the transferable synthetic data generation workflow in response to determining that the candidate workflow satisfies the external requirements.

16. A modular synthetic data generation system comprising:
an onboarding module configured to generate a transferable synthetic data generation workflow by
determining data properties of a locally-accessible seed dataset for inclusion in a candidate workflow,
selecting preprocessing actions and training actions for inclusion in the candidate workflow based on the data properties and external requirements for the seed dataset, the preprocessing actions comprising one or more of data ingestion actions, data conditioning actions, data encoding actions, and data privacy actions, and
storing the candidate workflow as a transferable synthetic data generation workflow in a remotely-accessible workflow storage; and
a training module logically isolated from the onboarding module and configured to generate a trained generative model using the transferable synthetic data generation workflow by
retrieving the transferable synthetic data generation workflow from the remotely-accessible workflow storage for an additional dataset having data properties similar to the data properties of the seed dataset,
preprocessing the additional dataset using the selected preprocessing actions,
training a model using the preprocessed additional dataset and the selected training actions to generate the trained generative model, and
storing the trained generative model in a remotely-accessible model storage.

17. The modular synthetic data generation system of claim 16, wherein the onboarding module is geographically isolated from the training module, the modular synthetic data generation system having an asymmetric decoupled architecture with distributed onboarding and training modules and the workflow storage as a shared database.

18. The modular synthetic data generation system of claim 16, further comprising:
a generation module logically isolated from both the onboarding module and the training module, the generation module being configured to generate a synthetic dataset using the trained generative model by
retrieving the trained generative model from the remotely-accessible model storage, and
generating the synthetic dataset using the trained generative model.

19. The modular synthetic data generation system of claim 18,
wherein the onboarding module is further configured to generate the transferable synthetic data generation workflow by selecting generation actions for inclusion in the candidate workflow based on the data properties and the external requirements for the seed dataset, and
wherein the generation module is configured to generate the synthetic dataset using the selected generation actions.

20. The modular synthetic data generation system of claim 19, wherein the onboarding module, the training module, and the generation module are mutually geographically isolated, the modular synthetic data generation system having an asymmetric decoupled architecture with distributed onboarding, training, and generation modules and the workflow storage and the model storage as shared databases.
